(19) United States
(12) Patent Application Publication
(10) Pub. No.: US 2005/0184705 A1
(43) Pub. Date: Aug. 25, 2005

(54) Method and system for providing a trickle charging current to a battery

(76) Inventors: George R. Gawell, Buffalo Grove, IL (US); Timothy Moss, Chicago, IL (US)

Correspondence Address: Paul J. Maginot;Maginot, Moore & Beck, Bank One Center/Tower, 111 Monument Circle, Suite 3000, Indianapolis, IN, 46204-5115, US

(21) Appl. No.: 10/783,690

(22) Filed: Feb. 20, 2004

(51) Int. Cl. H02J 7/00

(52) U.S. Cl. 320/160

(57) ABSTRACT

A system and method enables a fast charging current switch to be bypassed with a trickle charging current so a battery with a low internal resistance is not supplied a fast charging current. The fast charging current switch is enabled to supply a fast charging current to the battery in response to the battery voltage being at or above a threshold voltage. If the fast charging current switch is not enabled to provide the fast charging current then a bypass element provides the trickle charging current. Preferably, the bypass element is a resistor coupled across a transistor used to implement the fast charging current switch.

### FIELD OF THE INVENTION

The present invention relates generally to battery chargers, and more particularly, to battery chargers that detect low internal battery resistance to reduce the likelihood of a fast charging current being supplied to the battery.

### BACKGROUND OF THE INVENTION

Battery charging circuits are well known. Typically, these circuits convert an alternating voltage to a half-wave or fully rectified voltage form that is applied to a battery so the battery is recharged for further use. Many devices used today are powered with batteries that may be recharged. Such devices include cellular telephones, personal digital assistants (PDA), calculators, handheld tools, as well as many others. To keep the batteries at a level adequate to power these devices, the batteries must be occasionally recharged. Most of these devices are recharged by plugging electrical prongs extending from a housing into a household current outlet. The housing typically contains a step-down transformer and rectifier circuit that steps down the voltage to a range that is appropriate for charging batteries and rectifies the voltage signal so a DC signal may be used for charging the battery.

The remainder of the charger circuit may be internal to the device. This portion of the charging circuit couples the stepped down recharging signal to the battery. Typically, the coupling circuit includes circuitry for monitoring the voltage level of the battery as it is charged so the charging current is appropriately adjusted to the battery depletion level. That is, the rate of the recharging signal is greater at low battery levels and then reduced as the battery voltage recovers to its operational levels. The charging current rate may refer to the magnitude of the recharging current or to a pulse width modulation of the recharging current. Thus, the current regulation circuits supply power at greater rates at low battery levels to more quickly regenerate the battery capacity while slowing the charging current rate as the battery nears its full capacity to reduce the likelihood that the battery will overheat or explode from the recharging.

One problem that arises during battery recharging is the detection of shorted batteries. Because a battery being recharged represents a load placed across the recharging current source, a battery having no or little internal resistance effectively places a short circuit across the recharging circuit. A short circuit causes the recharging source to supply current at a rate that causes the battery to absorb a great deal of electrical energy. The recharging current will continue to be supplied during a shorted battery condition because the voltage across the low internal resistance of the battery, even at high current rates, is insufficient to trigger regulation of the recharging current. As a consequence, a battery may be supplied so much current that it may overheat and, perhaps, even explode.

In an effort to detect a low battery resistance during recharging of a battery, several circuits have been developed to detect low battery internal resistance and regulate recharging circuits accordingly. For example, U.S. Pat. No. 6,326,767 to Small et al. discloses the use of a comparator to detect a low battery voltage and generate a low battery signal for a recharging current controller. In response to the signal, the controller only applies a trickle charge to the battery until the battery adequately recharges to a level where its internal resistance is sufficient to absorb a fast recharging current. This system requires an active component, such as a controller, for current regulation to a battery with a low internal resistance. Other circuits, such as the one in U.S. Pat. No. 4,061,956 to Brown et al., simply decouple the battery from the recharging current when a low battery voltage level is detected. Other circuits employ a fuse or fusible link in the line to the battery so that current exceeding the rating of the fuse or link causes the fuse or link to become an open circuit. These circuits employing a fuse or fusible link completely decouple the battery from the charging circuit but they may deform in a way that causes a user to surmise that the battery has failed. As a result, the user may discard the battery when it simply needs a trickle charge to restore the battery to a level so it can accept a fast charging current.

Thus, previously known recharging systems that perform current regulation upon low battery voltage detection require expensive components, such as controllers or thyristors. The cost of components such as a controller or thyristors may significantly increase the production expense for an item. These components may also significantly add to the complexity of the recharging circuit. Circuits that decouple a battery from the recharging source upon detection of a low battery voltage may cause a user to prematurely discard a battery that could be recharged if provided a trickle charge for some period of time.

There is a need, therefore, for a recharging circuit that detects low battery voltages and provides a trickle recharging current without requiring expensive components.

There is a need for a recharging circuit that enables battery recharging at low battery internal resistance with reduced risk of short-circuiting the recharging circuit.

### SUMMARY OF THE INVENTION

The present invention addresses the above need, as well as others, by providing a system for recharging batteries with a low internal resistance. The system includes a fast charging current switch for coupling a fast charging current to a battery in response to the battery voltage being at or above a threshold level and a bypass element for coupling a trickle charging signal to the battery.

In one embodiment of a system for implementing the present invention, the bypass element is a resistor that is coupled between a fast charging current source and the battery to provide a trickle charging current to the battery. The resistor is typically sized in the range of approximately 47 to 470 Ω for a fast charging source supplying a fast charging current at a typical recharging voltage level of approximately 12 V. Any resistor and fast charging current combination that limits the trickle charging current to approximately 20 ma for a small battery of approximately 7.2 to 24 volts may be adequate to recharge the battery sufficiently to replenish the internal resistance of the battery. Once the internal battery resistance builds to a level where the battery exhibits a voltage drop across it that is at or above the threshold voltage, the fast charging current switch couples the fast charging current to the battery so that the resistor is effectively bypassed. Thus, the resistor enables the battery to receive a trickle charging current while it has a low internal resistance and then the fast charging current switch may couple a fast charge current to the battery once the internal resistance has built to a level that is at or above the threshold.

In one embodiment of a system implementing the present invention, the fast charging current switch includes a comparator that compares the battery voltage with the threshold voltage before generating a signal to couple the battery to the fast charging current. When the battery voltage is at or above the threshold voltage, the comparator generates a signal that may be used to couple a fast charging current to the battery. The threshold is a voltage that is approximately the same voltage that the battery produces when it has sufficient internal resistance to accept a fast charging current without generating excessive heat. For small tool, appliance, and cellular phone batteries, the threshold voltage is approximately 950 mV/cell.

In one embodiment of a system implementing the present invention, the signal from the comparator is coupled to a transistor so the transistor enables fast charging current flow to the battery. The current flow may be from the emitter to the collector or from the source to the drain of the transistor. By coupling the battery to one side of the transistor and the fast charging current to the other, the comparator may be used to selectively enable the transistor to couple the fast charging current to the battery in response to the battery voltage meeting or exceeding the threshold voltage.

In an embodiment of the present invention that includes a comparator for enabling a transistor to couple the battery to a fast charging current, the resistor may be coupled across the collector/emitter or drain/source of the transistor. When the comparator is not generating the enabling signal, the transistor is off and the battery is not coupled to the fast charging current. However, the fast charging current is limited by the resistor to generate a trickle charging current that is supplied to the battery. As the battery is recharged, its voltage increases towards the threshold voltage. Once it reaches the threshold voltage, the comparator enables the transistor to couple the fast charging current to the battery. The resistance through the transistor is low in comparison to the bypass resistor so practically all of the charging current is supplied as a fast charging current through the transistor. Thus, a trickle charge is effectively supplied to the battery through the resistor while the transistor is off and then a fast charging current is effectively supplied to the battery through the transistor once it is enabled by the comparator.

The comparator of the fast charging current switch in the embodiments discussed above preferably includes an operational amplifier that is configured as a comparator. The threshold signal is coupled to the reference voltage node of the comparator and the battery voltage is coupled to the differential input. In another embodiment of a system implementing the present invention, the fast charging current switch includes a first transistor that is coupled to the battery voltage so that when the battery voltage is at or above the zener voltage the transistor is enabled. A second transistor is coupled to the first transistor so that when the first transistor is enabled then the second transistor is coupled to a signal through the first transistor that turns on the second transistor. In response to the second transistor turning on, a fast recharging current is coupled to the battery through the second transistor. Preferably, the resistor discussed above is also coupled across the second transistor so that a trickle charging current is provided to the battery whenever the second transistor is not turned on.

In another embodiment of a system implementing the present invention, the fast charging current source is coupled to the battery and to the cathode of a zener diode. The anode of the zener diode is coupled to a transistor through a voltage divider. The collector/emitter or drain/source of the transistor is coupled between the battery and electrical ground so that when the battery voltage meets or exceeds the zener breakdown voltage, the voltage divider provides a signal to the transistor that turns it on and the battery is coupled between the fast charging current source and electrical ground. In this manner, a fast recharging current may be provided to the battery. Also coupled across the collector/emitter or drain/source of the transistor is a resistor that also couples the battery to electrical ground. The resistor is sized so that the battery draws a trickle charge current from the fast charging current source as long as the transistor remains off. However, once the trickle charge current replenishes the battery so that it has a voltage that meets or exceeds the zener breakdown voltage, the conducting path through the transistor has a lower resistance than the one through the resistor so the fast charging current is supplied to the battery.

A method for implementing the present invention includes coupling a trickle charging current to a battery through a bypass element in response to the battery voltage being below a threshold level and coupling a fast charging current to a battery in response to the battery voltage being at or above the threshold level.

In one method for implementing the present invention, the trickle charging current is coupled through a resistor that limits the current of the fast charging current supplied to the battery. The method includes sizing the resistor so that it limits the charging current to a trickle charge current of approximately 20 ma for a small battery of approximately 7.2 to 24 volts. The method also includes comparing the battery voltage to the threshold voltage and coupling a fast charging current to the battery in response to the battery voltage being at or above the threshold voltage. The fast charging current effectively bypasses the current limiting resistor. Thus, this method enables the battery to receive a trickle charging current while it has a voltage, and corresponding low internal resistance, that is below the threshold and then supply a fast charging current once the battery voltage and corresponding internal resistance has increased to a level that is at or above the threshold.

A method implementing the present invention may also include enabling a transistor to couple a fast charging current to the battery in response to the battery voltage being at or above a threshold voltage. By selectively enabling the transistor to couple the battery to the fast charging current, the battery is protected from receiving the fast charging current when its internal resistance is too low. The trickle charging current of the inventive method may also include bypassing the transistor with a resistor when the transistor is not enabled to provide a trickle charging current to the battery. Once the battery reaches the threshold voltage, the transistor is enabled to couple the fast charging current to the battery to finish charging the battery.

The comparison of the battery voltage to a threshold voltage includes configuring an operational amplifier as a comparator and coupling the threshold signal to the reference voltage node of the comparator and coupling the battery voltage to the differential input of the comparator. In another method implementing the present invention, the fast charging current coupling includes enabling a first transistor in response to the battery voltage equaling or exceeding the threshold level and enabling a second transistor coupled to the first transistor in response to the first transistor being enabled so that a fast charging current is coupled to the battery through the second transistor. Preferably, the method includes providing a trickle charging current to the battery through a current limiting resistor in response to the second transistor not being enabled.

Another method implementing the present invention includes detecting a battery voltage being at or above a threshold voltage with a zener diode and enabling a transistor to couple the fast charging current to electrical ground through the battery in response to the zener diode detecting the battery voltage being at or above the threshold voltage. The battery voltage meeting or exceeding the threshold voltage is detected by the battery voltage being at or above the breakdown voltage for the zener diode. The method also includes bypassing the transistor with a resistor so that the trickle charging current is coupled to electrical ground through the battery in response to the battery voltage being less than the breakdown voltage of the zener diode. However, once the trickle charge replenishes the battery so that the battery voltage meets or exceeds the zener breakdown voltage, the conducting path through the transistor has a lower resistance than the one through the resistor so the fast charging current is supplied to electrical ground through the battery.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows one embodiment of a system in which a trickle charging current is supplied to a battery through a bypass element;

FIG. 2 shows another embodiment of a system in which a trickle charging current is supplied to a battery through a bypass element;

FIG. 3 shows a third embodiment of a system in which a trickle charging current is supplied to a battery through a bypass element; and

FIG. 4 is a flow diagram of an exemplary method for providing a trickle charging current to a battery through a bypass element.

### DETAILED DESCRIPTION

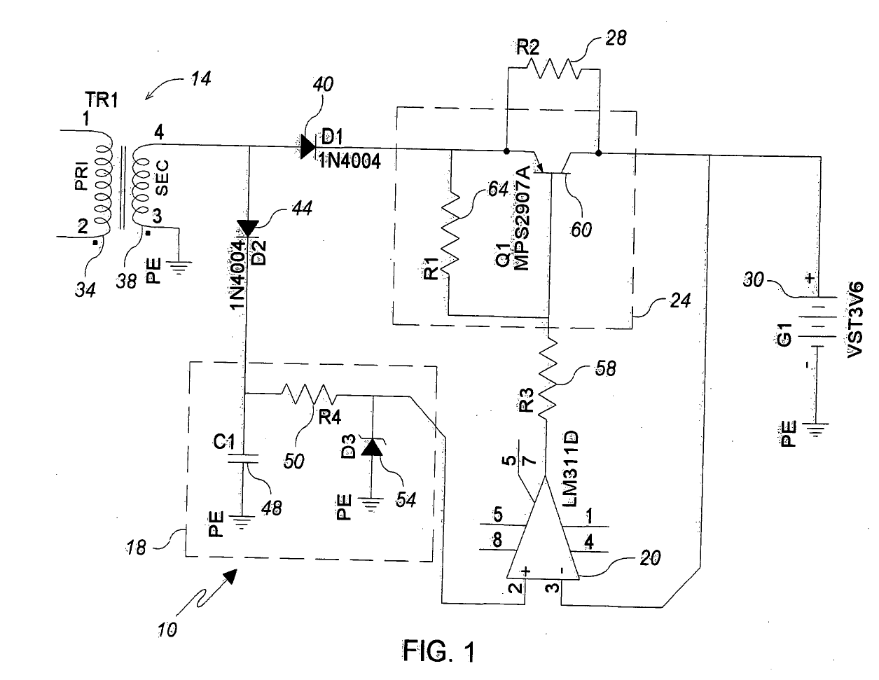

FIG. 1 shows a system 10 in which the principles of the present invention may be implemented. System 10 includes a step-down transformer 14, a reference signal generator 18, a comparator 20, a fast charge current switch 24, a bypass element 28, and a battery 30. The step-down transformer 14 reduces the voltage input signal input to the primary winding 34 of the transformer 14 so that a recharging signal having a lower voltage swing is produced at the output of the secondary winding 38. Typically, a household current of 120 VAC is provided on the primary winding 34 to generate an AC current signal on the secondary having a voltage of approximately 10 to 30 V. The secondary winding 38 is coupled to fast charge switch 24 through a diode 40 and to reference signal generator 18 through diode 44. The diodes 40 and 44 half-wave rectify the signal output by the secondary winding 38. Reference signal generator 18 includes a capacitor 48, a resistor 50, and a zener diode 54. The resistor/capacitor combination enables the capacitor to charge during the active portion of the half-rectified signal and then discharge through the resistor 50 during the portion of the signal that remains at zero volts. The zener diode 54 prevents the reference signal from exceeding its breakdown voltage. The reference voltage is provided to the non-inverting input of the comparator 20. The inverting input of the comparator 20 is coupled to the positive terminal of the battery 30. The output of the comparator is coupled to the fast charge current switch 24 through a resistor 58.

Fast charge current switch 24 includes a transistor 60 and a resistor 64. Transistor 60 is shown as a PNP transistor; however, a NPN transistor may be used to configure a fast charge current switch instead. Alternatively, fast charge current switch 24 may be configured with a field effect transistor as well as with a bipolar transistor. The half-wave rectified signal from the diode 40 is coupled to transistor 60 and bypass element 28. Preferably, bypass element 28 is a resistor, although other current limiting devices may be used. Resistor 28 limits the current that flows through it around transistor 60 to battery 30 when the transistor 60 is not enabled to conduct the fast charging current to the battery 30. The trickle charging current through the resistor 64 is approximately 20 ma for a battery having a rated of voltage of 7.2 to 24 V.

When system 10 is coupled to a battery 30 as shown in FIG. 1, the comparator 20 determines whether the battery voltage is less than the reference or threshold voltage generated by the reference signal generator 18. In response to the battery voltage being less than the reference signal, the output of the comparator 20 does not enable transistor 60 to conduct the fast charging current to the battery. Instead, a trickle charging current is conducted by bypass element 28 to the battery. Once the battery voltage builds under the effect of the trickle charge so that it equals or exceeds the reference voltage, the comparator 20 generates an output signal that enables the transistor 60 to conduct the fast charging current from the step-down transformer 14 to the battery 30 so the battery may be recharged more quickly.

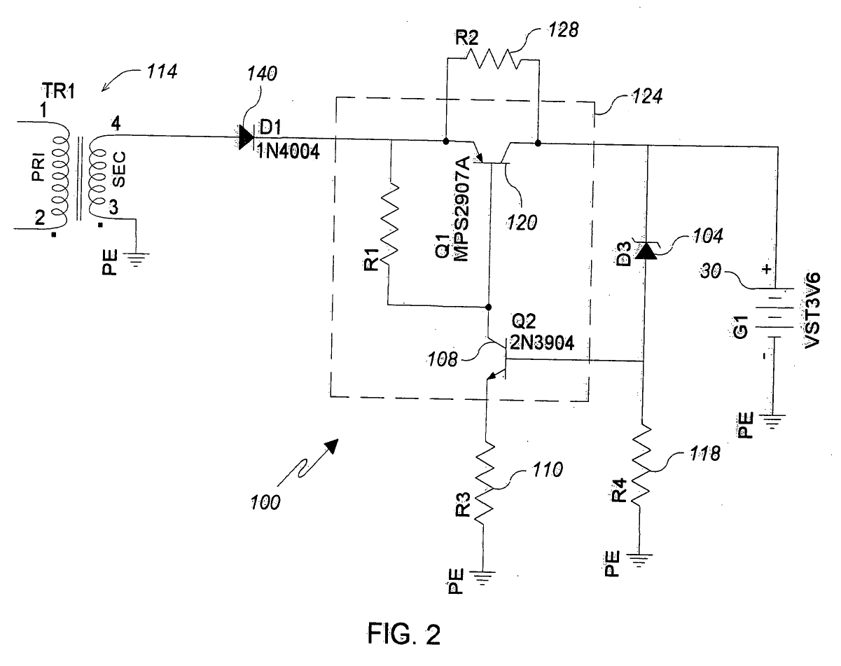

Another system in which the principles of the present invention may be implemented is shown in FIG. 2. System 100 includes a step-down transformer 114, a fast charging current switch 124, a bypass element 128, and a zener diode 104. A battery 30 is coupled to the system 100 for recharging. A diode 140 generates a half-wave rectified recharging signal from the signal generated by the step-down transformer 114. Fast charging current switch 124 of system 100 uses a second transistor 108 instead of a comparator 20. The transistors of the fast charging current switch 124 are preferably of the same type, but may both be bipolar or field effect transistors. As shown in FIG. 2, transistor 108 is coupled to electrical ground through a resistor 110 and the anode of the zener diode 104 is coupled to electrical ground through a resistor 118. When the battery 30 is coupled to the output of the fast charging current switch 124 and the bypass element 128, its voltage is presented at the cathode of the zener diode 104. If its voltage is less than the breakdown voltage of the zener diode then the second transistor 108 remains disabled and the first transistor 120 does not conduct the fast charging current through to the battery 30. However, the fast charging current is limited by the bypass element 128 to generate a trickle charging current that is provided to the battery 30. As the battery is replenished by the trickle charging current, its voltage increases until it exceeds the breakdown voltage of the zener diode 104. The resulting signal at the gate of the transistor 108 enables it to couple the gate of transistor 120 to electrical ground through the resistor 110. This enables the exemplary PNP transistor 120, as shown in FIG. 2, to conduct so that the fast charging current flows to the battery through the transistor 120. The battery 30 now charges more quickly.

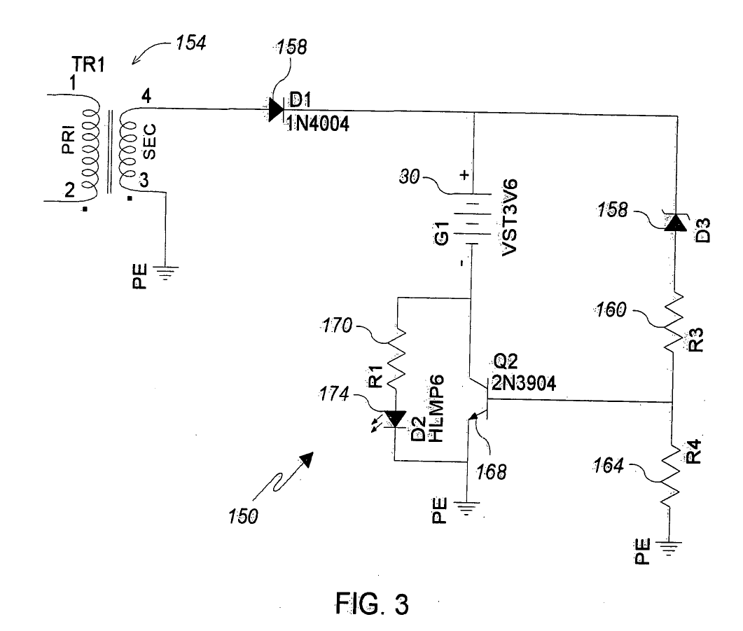

Another exemplary embodiment of a system implementing the present invention is shown in FIG. 3. System 150 includes a step-down transformer 154 that is coupled to the battery 30 through a diode 158 so that the battery 30 is coupled to a half-rectified signal. The battery 30 is also coupled to the cathode of a zener diode 158 that is coupled to electrical ground through a voltage divider comprised of resistors 160 and 164. The node of the voltage divider is coupled to the base of transistor 168 that also has its emitter coupled to electrical ground and its collector coupled to the negative terminal of the battery 30. Coupled across the transistor 168 are a resistor 170 and a light emitting diode (LED) 174.

When the battery 30 is coupled to the system 150 shown in FIG. 3, its voltage is sensed at the cathode of the zener diode 158. If the battery voltage is less than the breakdown voltage of the zener diode 158, then the transistor 168 is not enabled and no current flows from the negative terminal of the battery 30 to electrical ground through the transistor 168. However, a path through ground is presented through resistor 170 and LED 174. Because resistor 170 is sized to limit the current through it, the battery 30 only draws a trickle charging current from the half-wave rectified signal. Also, the current through the resistor 170 energizes LED 174 so that it generates a light to indicate the battery is receiving a trickle charge. Once the battery 30 reaches the breakdown voltage of the zener diode 158, a voltage at the common node of the voltage divider enables the transistor 168 to conduct and couple the negative terminal of the battery 30 to electrical ground. The battery 30 now draws a fast charging current through it and the current through the resistor 170 is insufficient to energize LED 174. Thus, the absence of a light being generated by LED 174 indicates that the battery 30 is receiving a fast charging current from the step-down transformer 154.

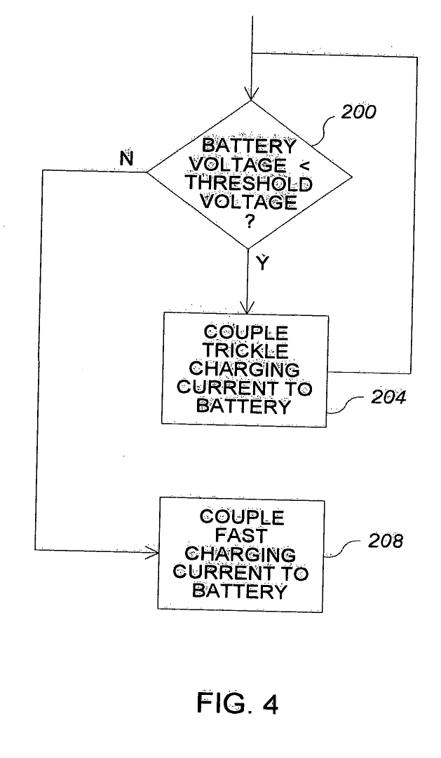

An exemplary method for recharging a battery is shown in FIG. 4. The method begins by detecting the battery voltage and determining whether the battery voltage is less than a reference voltage (block 200). If it is less than the reference voltage, a trickle charging current is coupled to the battery through a bypass element (block 204). The method continues to determine whether the battery voltage is less than the reference voltage and when it equals or exceeds the reference voltage, it supplies a fast charging current to the battery (block 208). A method according to the principles of the present invention may be implemented with a hardware system, such as one of those described above, or it may be implemented in a system using software and hardware.

In operation, a recharging system having a bypass element and a fast charging current switch is coupled between a battery and a step-down transformer. The fast charging current switch is enabled to provide a fast charging current to the battery if its voltage is at or above a reference voltage. If the battery voltage is less than the reference voltage, then a trickle charging current is provided through the bypass element to the battery. Once the battery voltage increases to the reference voltage level, the fast charging current is provided to the battery. This system reduces the likelihood that a fast charging current is applied to a battery having a low internal resistance that may electrically short-circuit the recharging supply.

While the present invention has been illustrated by the description of exemplary processes and system components, and while the various processes and components have been described in considerable detail, applicant does not intend to restrict or in any limit the scope of the appended claims to such detail. Additional advantages and modifications will also readily appear to those skilled in the art. The invention in its broadest aspects is therefore not limited to the specific details, implementations, or illustrative examples shown and described. Accordingly, departures may be made from such details without departing from the spirit or scope of applicant's general inventive concept.

1. A system for recharging a battery comprising:
a fast charging current switch for coupling a fast charging current to a battery in response to the battery voltage being at or above a threshold level; and
a bypass element for coupling a trickle charging current to the battery.

2. The system of claim 1 wherein the bypass element is a resistor coupled between a fast charging current source and the battery to provide a trickle charging current to the battery.

3. The system of claim 2 wherein the resistor is in the range of 100 to 2000 ohms.

4. The system of claim 1 wherein the fast charging current switch includes a comparator for comparing the battery voltage to the threshold level.

5. The system of claim 4 wherein the threshold level is approximately 950 mV/cell.

6. The system of claim 1 wherein the fast charging current switch includes a transistor and the output of the comparator is coupled to the transistor to enable the coupling of the fast charging current to the battery in response to the battery voltage being at or above the threshold level.

7. The system of claim 6 wherein the bypass element is coupled across the transistor of the fast charging current switch so that the trickle charge is conducted by the bypass element to the battery in response to the transistor of the fast charging current switch not being enabled.

8. The system of claim 1 wherein the fast charging current switch includes a first transistor coupled between a second transistor and electrical ground, the first transistor enabling the second transistor to conduct a fast charging current to the battery in response to the battery voltage being at or above the threshold level.

9. The system of claim 1 wherein the fast charging current switch includes a zener diode coupled between the battery and a transistor, the transistor also being coupled between the battery and electrical ground so that a battery voltage exceeding the breakdown voltage of the zener diode enables the transistor to couple the battery to ground and couple the fast charging current to electrical ground through the battery.

10. The system of claim 9 wherein the bypass element includes a resistor coupled between the battery and electrical ground and being coupled across the transistor so that the fast charging current is coupled to electrical ground through the battery and resistor to provide a trickle charge to the battery.

11. A method for recharging a battery comprising:
coupling a trickle charging current to the battery; and
coupling a fast charging current to a battery in response to the battery voltage being at or above a threshold level.

12. The method of claim 11 further comprising:
bypassing a fast current charging switch with a trickle charging current so that the battery is recharged at a trickle rate in response to the battery voltage being equal to or greater than the threshold level.

13. The method of claim 12 further comprising:
limiting the fast charging current to generate the trickle charging current.

14. The method of claim 11 further comprising:
comparing the battery voltage to the threshold level.

15. The method of claim 14, the comparison further comprising:
applying the battery voltage to the cathode of a zener diode.

16. The method of claim 11 further comprising:
enabling a transistor to couple the fast charging current to the battery in response to the battery voltage being at or above the threshold level.

17. The method of claim 16, the trickle charging current coupling further comprising:
bypassing the transistor with a trickle charging current in response to the transistor not being enabled to provide a fast charging current to the battery.

18. The method of claim 11 further comprising:
detecting with a zener diode whether the battery voltage is at or above the threshold level.

19. The method of claim 11 further comprising:
enabling a transistor to couple the fast charging current to electrical ground through the battery in response to the zener diode detecting that the battery voltage is at or above the threshold level.

20. The method of claim 19 further comprising:
bypassing the transistor with a resistor so that the trickle charging current is provided to electrical ground through the battery in response to the battery voltage being less than the breakdown voltage of the zener diode.
